(19) United States
(12) Patent Application Publication
(10) Pub. No.: US 2026/0094175 A1
(43) Pub. Date: Apr. 2, 2026

(54) SYSTEMS AND METHODS FOR DEMAND PLANNING, FORECASTING, AND PROCUREMENT

(71) Applicant: TARGET BRANDS, INC., Minneapolis, MN (US)

(72) Inventors: Aaron James JOHNSON, Saint Paul, MN (US); Brent MESSING, Gem Lake, MN (US); Ryan VILMO, Becker, MN (US); Guru NARAYANAN, Columbus, OH (US); Alec Winslow JANN, Saint Paul, MN (US); Margaret MERLINE, Seattle, WA (US); Rikhin BHUTA, Minneapolis, MN (US)

(21) Appl. No.: 18/902,377

(22) Filed: Sep. 30, 2024

(51) Int. Cl. G06Q 30/0202; G06Q 10/087

(52) U.S. Cl. CPC G06Q 30/0202; G06Q 10/087

(57) ABSTRACT

A software application is configured to receive item demand data and user inputs associated with a construction project, aggregate the item demand data and the user inputs, and generate a forecast for the item demand. The software application can generate and transmit notices (e.g., purchase orders, transfer orders) to a supply chain system based on the forecast of the item demand. Alternatively, the software application can transmit the forecast of the item demand to another software application that is configured to generate and transmit notices (e.g., purchase orders, transfer orders) to the supply chain system.

### TECHNICAL FIELD

This invention relates generally to project management software and systems, and more specifically to methods and apparatus for demand planning, forecasting and procurement software and systems.

### BACKGROUND

The management of collaborative projects, such as capital projects, can be challenging and time consuming. Inputs are received from a variety of sources, such as designers, contractors, vendors, warehouses, and the like. Some of the inputs relate to items that will be needed during a collaborative project. For example, when the collaborative project is the construction or remodel of a retail store, the items that will be used during the construction or remodel include fixtures such as lighting, flooring, and plumbing, and non-fixture items such as shelving, signage, and furniture. Planning and forecasting demand for the items can be challenging. In some instances, manual tracking of the items is performed and may require the creation and updating of various documents, such as multiple spreadsheet documents. Additionally, the items can be procured from a variety of sources, such as multiple vendors and warehouses. Tracking orders for the items and the receipt of the items may add to the complexity of the planning and forecasting process.

### SUMMARY

In one aspect, a system includes a processor and a memory. The memory stores processor-executable instructions, that when executed by the processor, cause operations to be performed. The operations include receiving, from a first computing device over a network, a planning document of a construction project and extracting, from the planning document, an item to be used in the construction project. Item demand data associated the item can be received from a second computing device over the network. The item demand data may be used in determining a demand for the item. A user input associated with the item is received from a third computing device over the network. The user input can be used in determining the demand for the item. Based on the item demand data and the user input, a forecast of item demand for the item is generated. Based on the forecast, a notice to a supply chain system to acquire the item is transmitted over the network.

In another aspect, a method includes receiving a blueprint of a construction project and extracting, from the blueprint, an item to be used in the construction project. Item demand data associated the item is received, where the item demand data can be used in determining a demand for the item. The item demand data is analyzed to determine whether information associated with the item is missing. Based on a determination that information associated with the item is missing, a graphical user interface (GUI) is transmitted to a computing device, where the GUI is configured to receive user inputs. A user input associated with the item is received, where the user input provides the missing information. Based on the item demand data and the user input, a forecast of item demand for the item is generated. Based on the forecast, a notice is transmitted to a supply chain system to acquire the item.

In yet another aspect, a computer-readable medium stores instructions, that when executed by one or more processors, cause operations to be performed. The operations include receiving a blueprint of a construction project and extracting, from the blueprint, an item to be used in the construction project. Item demand data associated the item is received, where the item demand data can be used in determining a demand for the item. The item demand data is analyzed to determine whether information associated with the item is missing. Based on a determination that information associated with the item is missing, a graphical user interface (GUI) is transmitted to a computing device, where the GUI is configured to receive user inputs. A user input associated with the item is received, where the user input provides the missing information. Based on the item demand data and the user input, a forecast of item demand for the item is generated. The forecast of item demand is transmitted to a computing device configured to execute a software application that is configured to transmit a notice to a supply chain system to acquire the item.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the figures.

FIG. 1 illustrates a block diagram of an example system for a collaborative project according to an embodiment of the disclosure;

FIG. 2 illustrates an example process flow for a construction project according to an embodiment of the disclosure;

FIG. 3 illustrates a flowchart of a first example method of demand planning, forecasting, and procurement of items according to an embodiment of the disclosure;

FIG. 4 illustrates an example process for demand planning, forecasting and procurement according to an embodiment of the disclosure;

FIG. 5 illustrates an example graphical user interface for implementing various embodiments in the examples described herein according to an embodiment of the disclosure;

FIG. 6 illustrates an example first graphical user interface that is configured to receive user inputs according to an embodiment of the disclosure;

FIG. 7 illustrates an example second graphical user interface that is configured to receive user inputs according to an embodiment of the disclosure;

FIG. 8 illustrates a flowchart of a second example method of demand planning, forecasting and procurement of items according to an embodiment of the disclosure; and

FIG. 9 illustrates a block diagram of an example computing system for implementing various embodiments in the examples described herein.

### DETAILED DESCRIPTION

The present disclosure relates generally to systems and methods for demand planning, forecasting, and procurement of items in collaborative projects. Embodiments described herein provide a software application, such as a portal application, which is configured to receive item demand data and user inputs associated with a construction project, aggregate the item demand data and the user inputs, and generate a forecast for the item demand. The software application can generate and transmit notices to a supply chain system based on the forecast of the item demand. In one embodiment, the notices may include purchase orders for purchasing the items and/or transfer orders to transfer items from a warehouse, and such notices are transmitted directly to the proper recipients in the supply chain system. The item demand data may be received from a project team, a vendor, a warehouse, a designer, and/or a contractor. Alternatively, in another embodiment, the notices may include information (e.g., the item demand data) that is used to generate purchase orders and/or transfer orders, and the information is transmitted to another software application that is configured to generate the purchase orders and/or transfer orders.

The software application can be configured to generate one or more graphical user interfaces (GUIs) and present information in the GUI(s). In some instances, a GUI may be configured to receive user inputs. For example, a GUI may be provided when information about a location, an item, a quantity, a vendor, a warehouse, and/or a contractor has not been input (e.g., is missing). The GUI can be configured to receive the missing information. Additionally or alternatively, a GUI may be provided that is configured to receive a confirmation and/or an approval for a portion of the item demand data. A GUI may also be presented that is configured to remedy an issue in the item demand data. For example, an item may not be included in a catalog for a vendor, so a GUI can be provided to correct the data (e.g., select a different vendor).

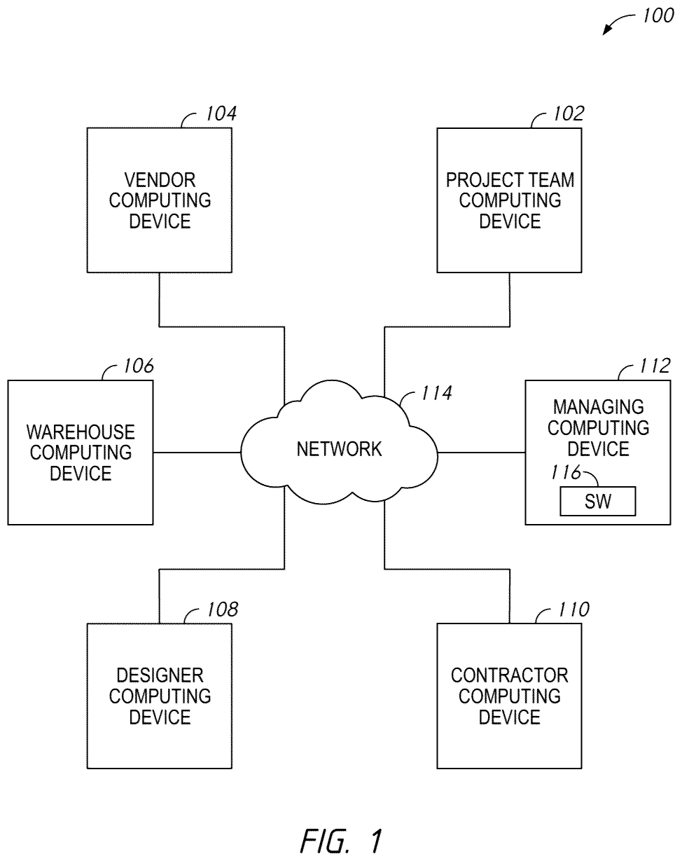

FIG. 1 illustrates a block diagram of an example system 100 for a collaborative project according to an embodiment of the disclosure. The system 100 may include a project team computing device 102, a vendor computing device 104, a warehouse computing device 106, a designer computing device 108, a contractor computing device 110, and a managing computing device 112. Although FIG. 1 shows only one of the project team computing device 102, the vendor computing device 104, the warehouse computing device 106, the designer computing device 108, the contractor computing device 110, and the managing computing device 112, other embodiments are not limited to this implementation. Systems in other embodiments can include one or more of each of the project team computing device 102, the vendor computing device 104, the warehouse computing device 106, the designer computing device 108, the contractor computing device 110, and/or the managing computing device 112.

The project team computing device 102 can be used by one or more in-house employees and managers that work on and/or manage the collaborative project. In one embodiment, the collaborative project is the construction of a new retail store or the remodel of an existing retail store (referred to herein as a “construction project”). However, in other embodiments, there can be multiple construction projects occurring simultaneously, concurrently (i.e., overlapping in time), or sequentially. Additionally or alternatively, the collaborative project can be any collaborative project that involves inputs from multiple sources, outputs to multiple sources, sub-projects, and the purchase and/or receipt of goods and services. For example, the collaborative project may be associated with operating a manufacturing plant, building an infrastructure project (e.g., new road), or managing a transportation system (e.g., airline maintenance).

The vendor computing device 104 may be used by a supplier, seller, enterprise, vendor, or other entity that provides or is able to provide items to the construction project. In one embodiment, the items are indirect items, where an indirect item is a non-retail item that is not sold by the store to a user (e.g., an end user or a consumer) but is instead used to build and/or remodel the store. For example, the items may include building materials, fixtures (e.g., lighting, plumbing, flooring, etc.), and/or non-fixtures (e.g., signage, marketing, shelving, kiosks, carts, etc.).

The warehouse computing device 106 may be used by a warehouse that provides or is able to provide storage for the items prior to, and during the construction project. The warehouse can also provide delivery services for the items that are used in the construction project.

The designer computing device 108 can be used by a designer or designers that design or assist in the design of the construction project. In some embodiments, the designer computing device 108 may be used to design the interior layout of the retail business, such as the aisles, the arrangement of different departments (e.g., clothing, grocery, electronics, pharmacy, backroom, administration, etc.), the arrangement of shelving units, endcap units, checkout displays, and shelf enhancements.

The contractor computing device 110 may be used by one or more persons (e.g., third-party contractors) that work or are able to work on and/or manage the construction project and/or sub-projects associated with the construction project.

In the disclosed embodiment, the managing computing device 112 can be used by the retail store (e.g., the company), an owner of the retail store, one or more in-house managers of the construction project, one or more employees of the retail store, and/or a third-party company, team, or organization that manages the construction project (collectively referred to as the manager). Planning, forecasting, and procuring items that are used in the construction project are part of the management of the construction project.

The project team computing device 102, the vendor computing device 104, the warehouse computing device 106, the designer computing device 108, and the contractor computing device 110 may be in communication with the managing computing device 112 through a network 114. One or more software applications or software modules (collectively referred to as software (SW) 116) executing on the managing computing device 112 can be configured to receive data (inputs, commands, etc.) from the project team computing device 102, the vendor computing device 104, the warehouse computing device 106, the designer computing device 108, and the contractor computing device 110, aggregate and process the data for use in or with the software 116, and provide data to the project team computing device 102, the vendor computing device 104, the warehouse computing device 106, the designer computing device 108, and/or the contractor computing device 110.

In one embodiment, the software 116 is a portal application that operates as a single point of access for the project team computing device 102, the vendor computing device 104, the warehouse computing device 106, the designer computing device 108, and the contractor computing device 110. The portal application may be configured to aggregate data that is received from the project team computing device 102, the vendor computing device 104, the warehouse computing device 106, the designer computing device 108, and the contractor computing device 110 and present the information in one or more GUIs. Additionally, in some embodiments, the managing computing device 112 can communicate and/or interact with a software application or a collection of distributed software modules operating on one or more of the project team computing device 102, the vendor computing device 104, the warehouse computing device 106, the designer computing device 108, and/or the contractor computing device 110.

The software 116 may be configured to receive inputs the managing computing device 112 receives from the project team computing device 102, the vendor computing device 104, the warehouse computing device 106, the designer computing device 108, and the contractor computing device 110 and provide one or more GUIs for different aspects associated the construction project. For example, the software 116 can provide a GUI that presents windows for demand planning and forecasting (e.g., demand planning for fixtures), vendor assignments, locations, commodity codes, catalog operations, item procurement, and the like.

In one embodiment, the managing computing device 112 may be implemented as a desktop computer, a laptop computer, a server, a mainframe computer, or a distributed computing system. The network 114 can be configured as one or more systems and protocols for communications between computing devices. Example network systems include, but are not limited to, a wide area network, a local area network, an enterprise private network, the Internet, a cloud-based network, or combinations thereof.

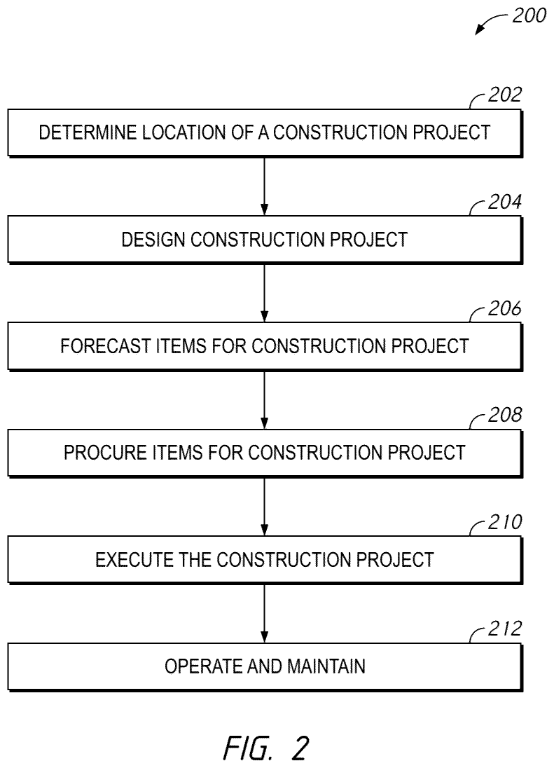

FIG. 2 illustrates an example process flow 200 for a construction project according to an embodiment of the disclosure. Although FIG. 2 is described in conjunction with one construction project, the example process flow 200 may be used for multiple construction projects where some or all of the construction projects occur at the same time, overlap in time, or occur at different times. The process flow 200 begins with determining a location of the construction project. In one embodiment, the construction project may be the construction of a new store or the remodeling or renovating of an existing store. At block 204, the construction project is designed. The design operation may include, but is not limited to, the generation of one or more blueprints, the generation of floor plans or layouts for architectural features, utilities, fixtures, and other property, receipt of building permits, and/or the generation of a final punch list.

At block 206, the items needed for the construction project are planned and forecast. In one embodiment, software (e.g., the software 116 in FIG. 1) may be used to manage the operations performed at block 206. For example, the software can be configured to provide one or more GUIs for different aspects associated the construction project based on inputs that are received from project teams, vendors, warehouses, designers, and contractors managing or working on the construction project.

At block 208, the items for the construction project are procured. In one embodiment, software (e.g., the software 116 in FIG. 1) may be used to manage the operations performed at block 208. In another embodiment, one or more additional software applications may be used to manage the operations performed at block 208.

At block 210, the construction project is executed. Once the construction project is completed, the process continues at block 212 where the completed construction project is operated and maintained. For example, when the interior of a retail business is remodeled and/or renovated, the retail business operates and maintains the building and the interior of the building.

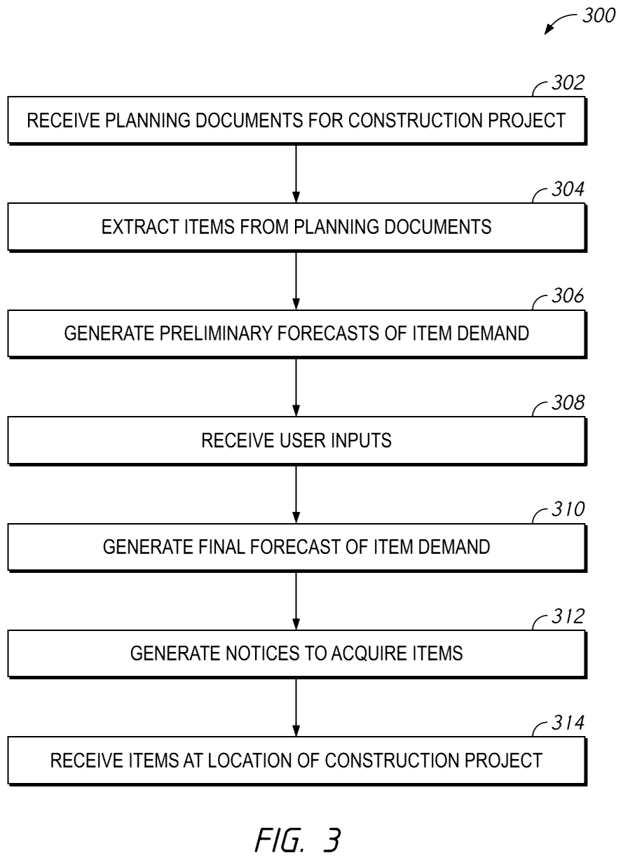

FIG. 3 illustrates a flowchart of a first example method 300 of demand planning, forecasting, and procurement of items according to an embodiment of the disclosure. Similar to FIG. 2, FIG. 3 is described in conjunction with one construction project, but other embodiments are not limited to this implementation. In some embodiments, blocks 206 and 208 of FIG. 2 include the operations shown in FIG. 3.

At block 302, one or more planning documents for the construction project are received. The one or more planning documents may include, but are not limited to, blueprints and/or floor plans or layouts. In one embodiment, the planning documents are received as computer-aided design (CAD) documents.

At block 304, the items to be used in the construction project are extracted from the planning document(s). The items can include one or both of fixtures and non-fixtures. In some instances, a bill of materials (BOM) is produced, where the BOM lists the items to be used in the construction project.

At block 306, one or more preliminary forecasts of the demand for the items (“item demand”) are received. In one embodiment, the software 116 on the managing computing device 112 extracts the item data at block 304 and generates the preliminary forecast(s) at block 306.

At block 308, inputs are received to finalize the item demand. The inputs may be received from the managing computing device in one embodiment. In another embodiment, the inputs can be received from one or more of the project team computing device, the vendor computing device, the warehouse computing device, the designer computing device, the contractor computing device, and/or the managing computing device. Additionally or alternatively, the user input can be made in one or more upstream systems that are then reconciled and processed by a computing device (e.g., the managing computing device).

In some instances, the item demand identifies the items to be obtained (e.g., purchased), the quantity, and the location(s) of where the items are to be delivered. The inputs can adjust one or items and/or the data associated with the items. For example, the data associated with the items may include the quantities of the items, delete one or more items, provide missing information for one or more items, modify vendor and/or warehouse assignments for one or more items, modify a location to receive one or more items, as well as other aspects of the items. In some embodiments, the software 116 on the managing computing device 112 may provide one or more GUIs that are configured to receive the user inputs.

At block 310, a final forecast of the item demand is generated based on the preliminary forecast of the item demand (block 306) and the inputs received at block 308. In one embodiment, the software 116 on the managing computing device 112 receives the inputs at block 308 and generates the final forecast of the item demand at block 310.

Notices are generated at block 312. In one embodiment, the notices may include purchase orders and/or transfer orders for the items. Purchase orders are generated to purchase items for the construction project from vendors, and transfer orders are produced to transfer items that are stored in the warehouse(s) to the construction project. In other embodiments, the notices can include information that is used in the generation of the purchase orders and transfer orders. The notices may be transmitted to another system (e.g., another software application) that is configured to generate and process the purchase orders and transfer orders. In one embodiment, the software 116 on the managing computing device 112 generates the notices.

At block 314, the items are received at the construction project from the vendors and/or the warehouses. The items may be received by contractors and/or project teams (e.g., employees) at the location of the construction project. In some implementations, the items can be received at the construction project and/or at one or more offsite locations.

In some embodiments, a system (e.g., the software 116 of FIG. 1) is configured to receive and process changes to the item demand at other points during the method and/or after the method is performed. For example, block 308 can be performed after block 312 or block 314 is performed. Blocks 308, 310, 312 and 314 may be performed for changes that are received during or after the performance of the method shown in FIG. 3.

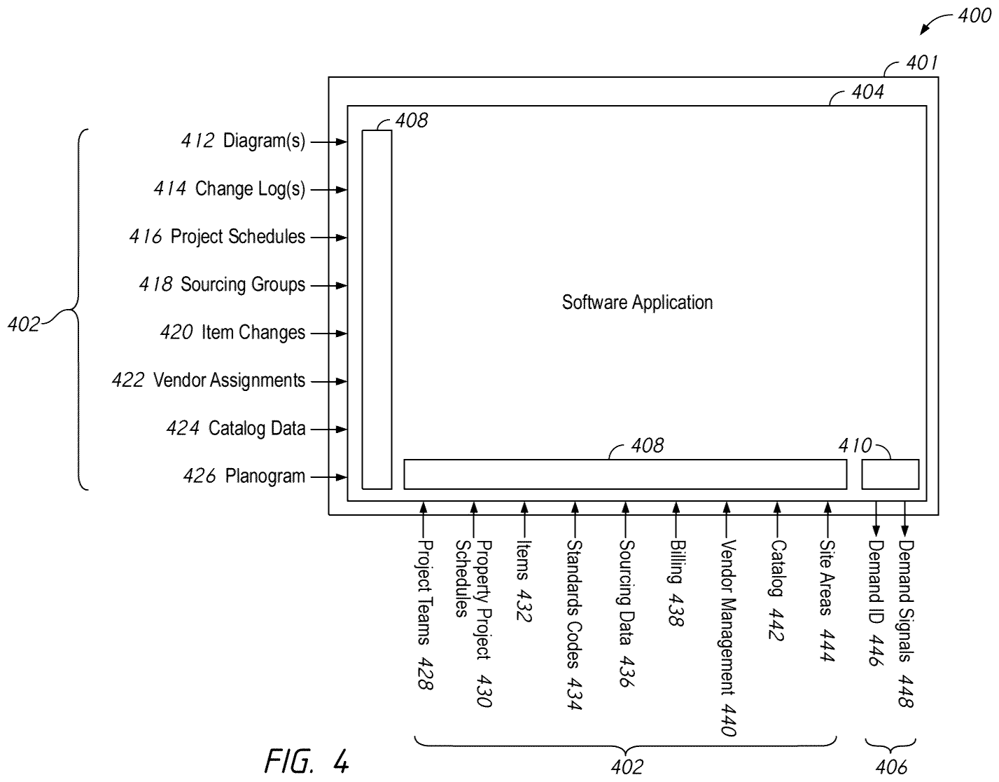

FIG. 4 illustrates an example process 400 for demand planning, forecasting and procurement according to an embodiment of the disclosure. The process 400 includes example inputs 402 that are received at a software application 404 executing on a computing device 401 (e.g., the software 116 on the managing computing device 112 of FIG. 1). The process 400 further includes example outputs 406 that may be provided by the software application 404. In one embodiment, the software application 404 is a portal application, the inputs 402 are received via a proxy service 408, and the outputs 406 are provided through an application programming interface 410.

The inputs 402 may include one or more diagrams 412 and associated change logs 414. In one embodiment, the diagram(s) 412 and the change log(s) can be received from the designers and/or the project team(s) associated with the construction project (e.g., the project team computing device 102 and/or the designer computing device 108 of FIG. 1). The diagram(s) 412 and the change log(s) 414 can be included in the planning documents of block 302 in FIG. 3. The diagram(s) 412 can be one or more blueprints that are received as CAD files of a store. The diagram(s) can include the location of the store in addition to blueprint(s) of the store. The software application 404 is configured to split and/or parse the CAD diagram(s) to determine the items that will be used in the construction project. In one embodiment, the items can be fixtures and/or non-fixtures of indirect items, although other embodiments are not limited to this implementation.

The inputs 402 can include one or more project schedules 416 for the construction project, one or more sourcing groups 418 for the construction project, and/or information on item changes 420 for the construction project. The one or more project schedules 416 can provide information (e.g., dates) when the construction project is to receive the items. The sourcing group(s) 418 and item changes 420 may be received from one or more project teams that are working on and/or managing the construction project. In one embodiment, the sourcing group(s) 418 and the item changes 420 can provide project specific inputs, where the project is the entire construction project or is a sub-project of the construction project. For example, a sub-project may be a section of the store (e.g., a department such as clothing) in which specific inputs are received.

The inputs 402 may include one or more vendor assignments 422 for the items to be used in the construction project and/or catalog data 424. The one or more vendor assignments 422 can provide a list of vendors and which items the vendors are supplying or are able to supply. In one embodiment, the vendor assignments may be preloaded. Additionally or alternatively, a supply contract the manager has with a vendor can guide the vendor assignment. The catalog data 424 may include a list of items to be supplied to the construction project.

In some embodiments, the inputs 402 can include one or more planograms 426 for the construction project. In one embodiment, a planogram is a schematic drawing that can indicate the placement of the retail products within the store (e.g., placement on shelves) as well as a layout of the entire store.

The inputs may include one or more project teams 428 and one or more property project schedules 430. The project team(s) 428 can include team members that are working one and/or managing the construction project or a sub-project. In some embodiments, a project team 428 or a team member on a project team 428 may be provided with a notification or a GUI configured to receive a confirmation and/or an approval that is associated with the construction project. For example, a project team 428 can provide information to complete a process (e.g., fill in a gap in the information) as part of the item demand planning, forecast and/or procurement processes. The property project schedule(s) 430 may be a schedule for the construction project or a sub-project of the construction project.

The inputs 402 can include items 432 and standards codes 434. In one embodiment, the standards codes 434 can be configured as the United Nations Standard Products and Services Code (UNSPSC) that is a global, multi-sector standard for classifying goods and services (e.g., items). The items 432 and standards codes 434 enable the correct code and information for any item to be provided.

The inputs 402 may include sourcing data 436 and billing codes 438. The sourcing data 436 may provide project specific information, where the project is the entire construction project or is a sub-project of the construction project. The billing codes 438 may be used to generate purchase orders, invoices, receive financial tracking information, and receive other information associated with billing.

In some embodiments, the inputs 402 can include vendor management 440 that provides information to vendors and/or about vendors working on and/or managing the construction project. The vendor management 440 may include a master list of all vendors assigned or available to the construction project. The catalog 442 can provide information on supplier contracts for different items associated with the construction project. Site areas 444 can provide information on one or more departments or areas within a store (e.g., within the construction project). Example site areas include, but are not limited to, baby and infant, pharmacy, menswear automotive, shoes, maternity, and furniture.

The outputs 406 may be provided on multiple subjects based on received requests (e.g., API calls). For example, the outputs 406 may include demand identification (ID) 446 and demand signals 448. The demand ID 446 may include information related to the demand of an item. For example, the demand ID can use a combination of a store location and a project schedule to create groups of items and/or select items (e.g., use a combination of the inputs 402 of the diagram(s) 412 and the project schedules 416). The demand signals 448 may include information such as source identification, description, and an identifier for an item.

The software application 404 is configured to extract item data from the diagram(s) 412, determine a preliminary forecast of item demand, receive user inputs, determine a final forecast of the item demand, generate the item demand, and generate notices regarding the item demand (e.g., transmit purchase orders or transfer orders). Based on the inputs 402, the software application 404 can determine which items are to be purchased, the quantity, and the vendor to be used to purchase the items, and which items are to be transferred from a warehouse, the quantity, and the warehouse to transfer the items. In some embodiments, the software application 404 is configured to transmit the item demand to a second software application that is configured to generate the notices and/or for financial purposes (e.g., financial tracking, billing, or payment).

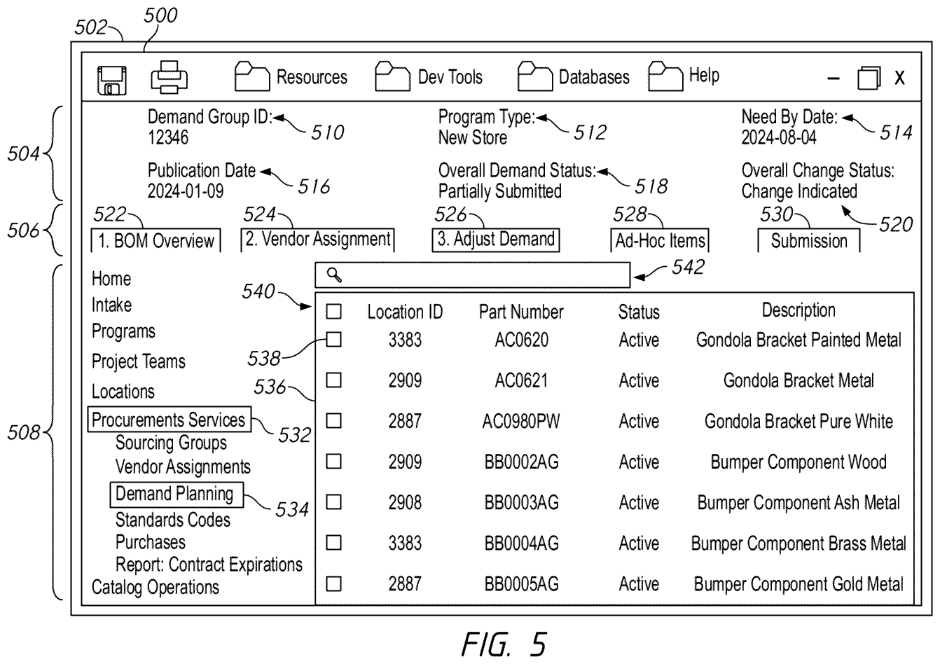

The software application 404 can aggregate the inputs 402 to identify the items for the construction project, the quantities of the items, and the location(s) where the items are to be received (e.g., a warehouse and/or the site of the construction project). Additionally, in some embodiments, the software application is configured to determine if there are any gaps in the information needed for the demand planning, forecasting, and/or procurement processes and notify the manager of the gaps. For example, rules, logic, and/or artificial intelligence (AI) may be applied to the information to make decisions regarding the construction project (e.g., item demand planning, forecasting, and/or procurement) and/or to determine if there are any gaps in the information. The software application 404 may apply the rules, logic, and/or AI to generate one or more GUIS to transmit to a computing device to enable the manager to view and/or edit the information. For example, the software application 404 can be configured to generate one or more GUIs to present information associated with the construction project, receive user inputs to receive information to fill in the gaps and/or to input or adjust an item, a quantity of an item, a vendor assignment, a site of a construction project, a quantity or other attribute, and the like. Example GUIs are shown and described in more detail in conjunction with FIG. 5 through FIG. 7.

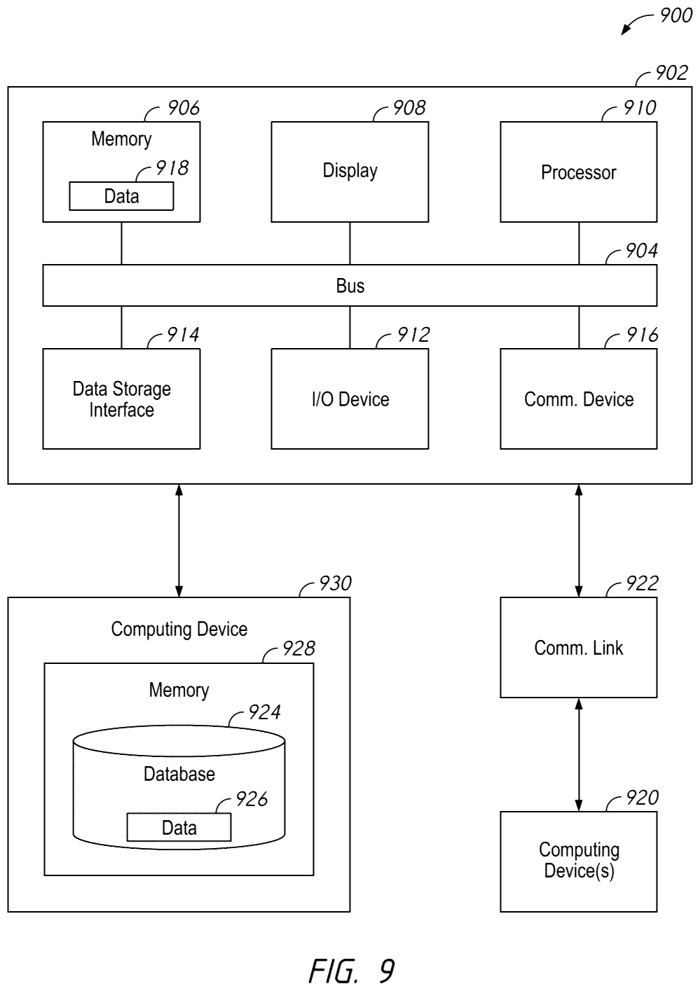

FIG. 5 illustrates an example GUI 500 for implementing various embodiments in the examples described herein according to an embodiment of the disclosure. The GUI 500 is displayed on a display device 502 (e.g., the display 908 of FIG. 9). The GUI 500 is configured to provide information on various aspects of the demand planning, forecasting and procurement for a construction project. The GUI 500 includes an information section 504, a tabs section 506, and a menu section 508. The information section 504 presents various information on the construction project. For example, in the illustrated embodiment, the information section 504 includes a demand group identifier (ID) 510, a program type 512, a need by date 514, a publication date 516, an overall demand status 518, and an overall change status 520.

The tabs section 506 presents selectable tabs for various processes of the demand planning, forecasting and procurement processes for the construction project. In FIG. 5, the tabs include BOM overview 522, vendor assignment 524, adjust demand 526, ad-hoc items 528, and submission 530. A manager can select one of the selectable tabs and a menu and information associated with that tab may be displayed in the GUI 500 (e.g., in a window created within the GUI or in a separate window). The BOM overview tab 522, when selected, can display the BOM for review. The Vendor Assignment tab 524 may be selected to display the available vendors for the items in the BOM. The Adjust Demand tab 526, when selected, can display a list of the items and be configured to allow the manager to adjust information associated with an item. The Ad-Hoc Items tab can be selected to allow the manager to convert an item into an ad-hoc item where the manager is prompted to specify units of measure (UoM), quantity, price, and other attributes. The Submission tab 530, when selected, can cause some or all of the item demand to be processed further. For example, some or all of the item demand can be transmitted to a software application that is configured to generate purchase orders and/or transfer orders. In some embodiments, the Submissions tab 530 may be selected to display information on the status and progress of prior submissions.

The menu section 508 presents options associated with a selected tab in the tab section 506. In FIG. 5, the adjust demand tab 526 is shown as selected, so the menu section 508 presents a menu associated with the adjust demand tab 526. The menu section 508 presents a list of options associated with multiple construction projects that the manager can select to view details on that option. In the illustrated embodiment, the menu section 508 is implemented as a cascading menu, but other embodiments are not limited to this configuration. For example, the menu section 508 includes top options of a home option, an intake option, a programs option, a project teams option, a locations option, a procurement services option, and a catalog options. The option of procurement services includes sub-options of sourcing groups, vendor assignments, demand planning, standards codes, purchases, and a report of contract expirations.

Selection of an option or a sub-option can cause another window to open and be displayed. For example, in FIG. 5 the procurement services 532 option and the demand planning 534 sub-option are selected, which causes the window 536 to open and display information related to the demand planning 536 sub-option. The window 536 presents information related to the different items, including the site locations of the construction projects (by location identifier (ID), part numbers of the items, a status associated with an item, and a description of the item.

The manager can select a particular item using a checkbox. For example, the checkbox 538 for the row 540 is shown as selected, which can cause another window or GUI to open to enable the manager to view additional information on that item, or to enable the manager to adjust the information associated with that item. The GUI 500 may further include a search box 542 to enable the manager to search for a particular location, part number, and/or description.

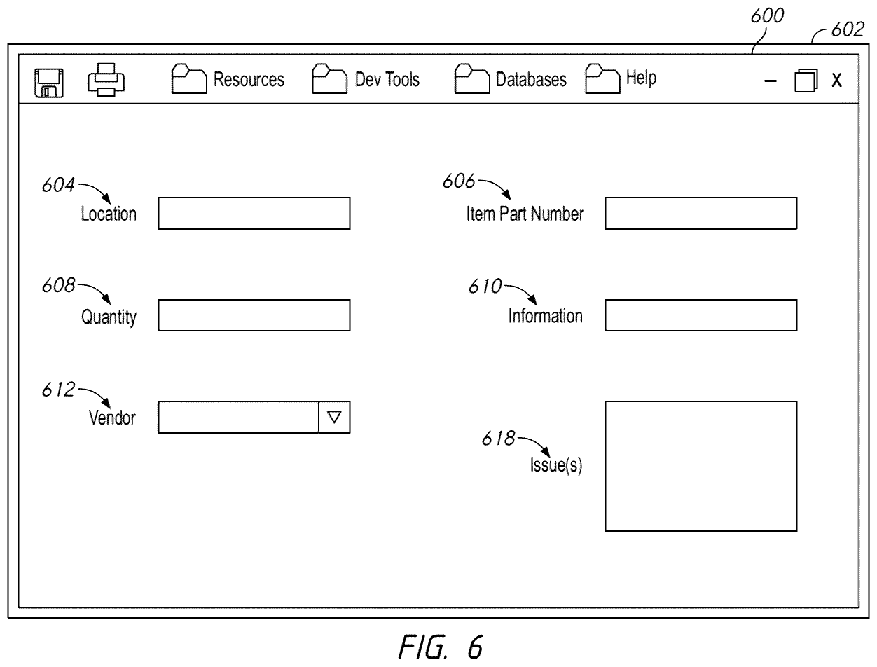

FIG. 6 illustrates an example first GUI 600 that is configured to receive user inputs according to an embodiment of the disclosure. The GUI 600 is displayed on a display device 602 (e.g., the display 908 of FIG. 9). The GUI 600 allows the manager to input and/or revise various aspects of the demand planning, forecasting, and procurement of an item or a location. In one embodiment, the GUI 600 can be provided in response to the manager selecting an item in the GUI 500 shown in FIG. 5 (e.g., select the checkbox 538). In another embodiment, the GUI 600 may be provided to the manager when information about a location, an item, a quantity, and/or a vendor has not been input (e.g., is missing). For example, the software application 404 shown in FIG. 4 can determine if information is missing and cause the GUI 600 to be transmitted to a computing device.

The GUI 600 presents a location input 604 that can enable the manager to generate information about a particular location of a construction project (e.g., a list of items for the particular location). For example, the manager can enter an identifier for a location and another window or GUI may be displayed that includes a list of the items for that location. In one embodiment, the manager may edit the list of items by selecting the item (e.g., select the checkbox 538).

The GUI 600 may further include an item part number input 606 that may enable the manager to generate information for the item, generate a list of locations and/or vendors associated with that item, and/or adjust one or more aspects associated with that item. For example, the manager can adjust the quantity using the quantity input 608, input any missing or additional information for the item using the information input 610, input or adjust the vendor assigned to the item using the vendor input 612. Issues may be provided to the manager for resolution via the text box 618. For example, an item may not be included in the catalog for a vendor the manager has selected, so the manager is notified of the issue to correct the data (e.g., select a different vendor using the vendor input 612). The manager may remedy the issue using, for example, the quantity input 608, the information input 610, the vendor input 612, or another input. In some embodiments, items that have unremedied issues cannot be submitted for processing (e.g., via the Submissions tab 530 in FIG. 5), which results in the requirement that all issues associated with the item demand be resolved prior to submission.

In one embodiment, the vendor assignments may be assigned default inputs or recommendations of inputs that the manager can change via the vendor input 612. The default inputs or the recommendations of inputs may be provided based on contracts between the manager and the vendor. Additionally or alternatively, a user input to change a vendor may be blocked based on contracts between the manager and the vendor.

Although FIG. 6 depicts the user inputs in one GUI, other embodiments are not limited to this implementation. One or more of the location 604 input, the item part number 606 input, the quantity 608 input, the information 610 input, the vendor 612 input, and the issues 618 input may be presented in one GUI or in multiple GUIs. Additionally, some of the user inputs are depicted as text boxes and others as dropdown menus. Other embodiments are not limited to this implementation. Any type of selection elements may be used, such as radio buttons, checkboxes, label buttons, and/or sliders.

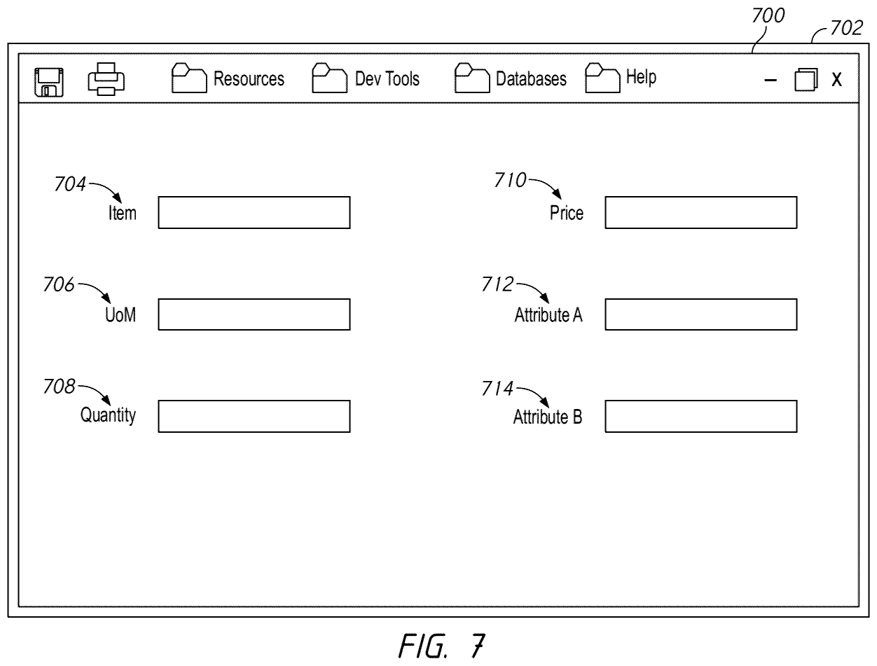

FIG. 7 illustrates a second example GUI 700 that is configured to receive user inputs according to an embodiment of the disclosure. The GUI 700 is displayed on a display device 702 (e.g., the display 908 of FIG. 9). In one embodiment, selection of the Ad-Hoc tab 528 shown in FIG. 5 causes the GUI 700 to be displayed.

The GUI 700 can include an item input 704 that is configured to receive an identifier for an item. The identifier may be a name, a part number, a catalog number or some other identifier. Entry of the item identifier can enable the manager to input additional attributes associated with the item. For example, one or more UoMs for the item can be input using the UoM input 706. A quantity for the item may be input using the quantity input 708. A price can be input using the price input 710. One or more other attributes that are associated with the item may be input using the attribute A input 712 and/or the attribute B input 714.

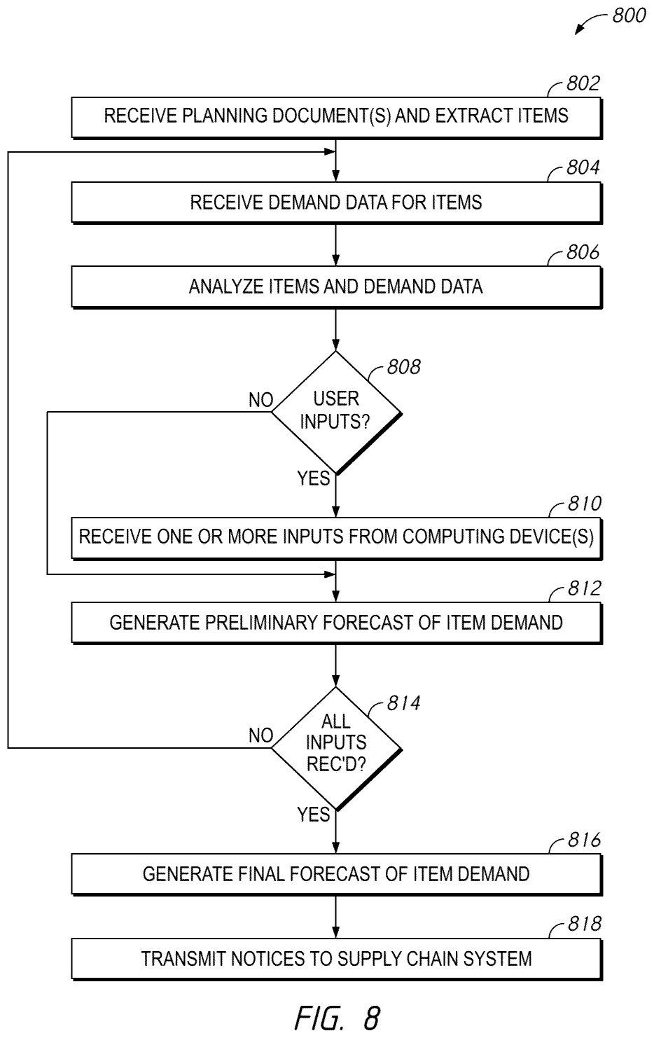

FIG. 8 illustrates a flowchart of a second example method 800 of demand planning, forecasting and procurement of items according to an embodiment of the disclosure. The method 700 may be performed by a software application, such as a portal application, running on a computing device or computing system (e.g., computing system 900 shown in FIG. 9). At block 802, one or more planning documents of the construction project are received and the items to be used in the construction project are extracted from the planning document(s). As described earlier, the planning document can include diagrams of the construction project. The software application is configured to split and/or parsed the diagram(s) into the items that will be used in the construction project. In one embodiment, the one or more diagrams are received as CAD diagrams from one or more computing devices associated with a designer and/or a project team.

At block 804, item demand data is received for the computation of a preliminary item demand. The item demand data may be received from computing devices that are associated with vendors, warehouses, designers, contractors, project teams, and/or a manager associated with the construction project. The item demand data may include location assignments, quantities needed, item part numbers, item descriptions, vendor assignments, and the like. For example, the item demand data can include some or all of the inputs 402 shown in FIG. 4.

At block 806, the item demand data is analyzed to determine if any data is missing and/or requires user input. For example, a vendor may need to be assigned to an item, or an item part number may be missing. As described earlier, rules, logic, and/or AI may be applied to the item demand data to make decisions regarding the construction project (e.g., item demand planning, forecasting, and/or procurement) and/or to determine if there are any gaps in the information (e.g., missing information).

A determination is made at block 808 as to whether one or more user inputs are needed or are to be received. If a determination is made that user inputs are to be received, the method passes to block 810 where the user input(s) are received. The user inputs may provide adjustments, edits, deletions, additions, or other modifications to the item demand data. For example, a vendor assignment may be changed from one vendor to another vendor. Additionally or alternatively, a quantity of an item at a particular location can be adjusted. In some instances, missing information can be received, or information may need to be confirmed or approved by the manager. Issues may be provided to the manager for resolution. For example, an item may not be included in the catalog for a vendor the manager has selected, so the manager is notified of the issue to correct the data (e.g., select a different vendor). One or more GUIs that are configured to receive the user inputs may be provided to one or more computing devices.

After block 810, or when a determination is made at block 808 that user inputs will not be received, a preliminary forecast of item demand is generated at block 812. The preliminary forecast of the item demand can identify each item, the quantity of the item to be acquired, and the supplier of the item (e.g., vendor or warehouse). At block 814, a determination is made as to whether all of the inputs and item demand data for planning, forecasting and procurement has been received. If a determination is made that all of the inputs and item demand data have not been received, the method returns to block 804 and blocks 804, 806, 808, 812 and 814 or blocks 804, 806, 808, 810, 812, and 814 repeat until a determination is made that all of the inputs and item demand data have been received.

When the determination is made that all of the inputs and item demand data have been received, the method continues at block 816 where a final forecast of the item demand is generated. The final forecast of the item demand can identify each item, the quantity of the item to be acquired, and the supplier of the item (e.g., vendor or warehouse). Notices for the provision of the final item demand are transmitted to the supply chain system. As described earlier, the notices may be purchase and/or transfer orders for particular items in the final forecast of the item demand or information that is used to generate purchase and/or transfer orders. A second software application may be configured to receive the information and generate and transmit the notices to the supply chain system. The second software application can be operating on a managing computing device (e.g., the managing computing device 112 of FIG. 1) or on another computing device. In one embodiment, the supply chain system can include vendors and warehouses.

The systems, methods, and user interfaces disclosed herein may be implemented using various computing systems. FIG. 9 illustrates a block diagram of an example computing system 900 for implementing various embodiments in the examples described herein. For example, the project team computing device 102, the vendor computing device 104, the warehouse computing device 106, the designer computing device 108, the contractor computing device 110, and/or the managing computing device 112 shown in FIG. 1 may include or be implemented as the computing system 900. This disclosure contemplates any suitable number of computing systems 900. For example, the computing system 900 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 900 may include one or more computing systems; be unitary or distributed; span multiple locations; span multiple locations; span multiple machines; span multiple data centers; or reside in a cloud, which may include one or more cloud components in one or more networks.

Computing system 900 includes a first computing device 902 that includes one or more communication structures, such as a bus 904 (e.g., an address bus and a data bus) or other communication mechanism for communicating information, which interconnects subsystems and devices, such as memory 906, a display 908, a processor 910, an input/output device 912, a data storage interface 914, and a communications device 916. Although only one of each component is shown in FIG. 9, other embodiments can include one or more of the bus 904, the memory 906, the display 908, the processor 910, the input/output device 912, the data storage interface 914, and/or the communications device 916.

The memory 906 is configured to store information, such as data and software applications (collectively data 918). In one embodiment, the data 918 can include some or all of the information relating to item demand planning, forecasting, and procurement, rules, logic and/or AI programs, and processor-executable instructions for one or more software applications. The information relating to item demand planning, forecasting and procurement may be stored in one or more databases in the memory 906. The data 918 can include different or additional data in other embodiments. The memory 906 may be implemented as one or more types of volatile and non-volatile memory. For example, the memory 904 can be a read only memory (ROM), dynamic and/or static random-access memory (RAM), flash memory, cache memory, erasable programmable ROM (EPROM), electrically erasable programmable ROM (EEPROM), virtual memory, optical memory, magnetic memory, and combinations thereof.

In particular embodiments, the processor 910 includes hardware for executing processor-executable instructions, such as the instructions in a software application. The processor 910 includes circuitry for performing various processing functions, such as executing specific software for perform specific calculations or tasks. For example, the processor 910 may be implemented as a microprocessor, a central processing unit, a graphics processing unit, a neural processing unit, a digital signal processor, or combinations thereof.

The bus 904 can include one or more memory buses (which may each include an address bus and a data bus) that couple the processor 910 to the memory 906. In particular embodiments, one or more memory management units (MMUs) reside between the processor 910 and the memory 906 and facilitate accesses to the memory 906 as requested by the processor 910. In particular embodiments, the bus 904 includes hardware, software, or both coupling components of the computing device 902 to each other.

The display 908 includes circuitry and a display screen and is configured to present information on the display screen. The display 908 can be the display device 502, the display device 602, or the display device 702 shown in FIG. 5, FIG. 6 or FIG. 7, respectively, and may be used to display the information described herein (e.g., via a GUI).

In particular embodiments, the I/O device 912 includes hardware, software, or both, providing one or more interfaces for communication between the I/O device 912 and other components within the computing device 902 and/or external to the computing device 902. One or more of the I/O devices 912 may enable communication between a user and the computing device 902. The I/O device 912 can include, but is not limited to, a keyboard, a keypad, a mouse, a microphone, speakers, input buttons, and combinations thereof. In some embodiments, the display 908 may also function as an I/O device when the display 908 is implemented as a touchscreen display that is configured to receive touch and/or force inputs as well as display information.

In particular embodiments, the communication device 916 includes hardware, software, or both providing one or more interfaces for communication (such as, for example, packet-based communication) between the computing device 902 and one or more other computing devices 920. Example communications devices 916 include, but are not limited to, a modem, an Ethernet card, a network interface controller (NIC) or network adapter for communicating with an Ethernet or other wire-based network, a wireless NIC (WNIC) or wireless adapter for communicating with a wireless network, such as a WI-FI network, and combinations thereof.

According to particular embodiments, the computing device 902 performs specific operations by the processor 910 executing one or more sequences of one or more processor-executable instructions stored in the memory 906. For example, processor-executable instructions for one or more of the GUIs and/or processor-executable instructions for one or more of the methods described herein may be stored in the memory 906 and may be executed by the processor 910. Such processor-executable instructions may be read into the memory 906 from another computer readable/usable medium, such as removable computer readable/usable medium (e.g., memory sticks, external hard drives). In alternative embodiments, hard-wired circuitry may be used in place of or in combination with processor-executable instructions. Thus, particular embodiments are not limited to any specific combination of hardware circuitry and/or software. In various embodiments, the term “logic” means any combination of software or hardware that is used to implement all or part of the particular embodiments disclosed herein.

The term “computer readable medium” or “computer usable medium” as used herein refers to any medium that participates in providing instructions to processor 910 for execution. Such a medium may take many forms, including but not limited to, nonvolatile media and volatile media.

The computing device 902 may transmit and receive messages, data, and instructions, including software applications (or processor-executable instructions) through a communications link 922 and the communications device 916. Received processor-executable instructions may be executed by the processor 910 as it is received, and/or stored in the memory 906 for later execution. In various examples, the communications link 922 may be configured as a network (e.g., the network 114 of FIG. 1) to enable the computing device 902 to communicate with, for example, other computing devices 920.

The computing system 900 may further include one or more databases (database 924) that may be used to store data and/or software applications (collectively data 926). In one embodiment, the data 926 can include some or all of the information relating to item demand planning, forecasting, and procurement, rules, logic and/or AI programs, and processor-executable instructions for one or more software applications. The data 926 can include different or additional data in other embodiments.

The database 924 can be accessed by the computing device 902 by way of the data storage interface 914 and/or the communications device 916. The database 924 can be stored in a memory 928 that is included in another computing device 930. The memory 928 may be implemented similar to the memory 906, and the computing device 930 can be implemented as the computing device 902. As such, the memory 928 and the computing device 930 are not described in detail.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of as defined in the claims. Although various embodiments have been described above with a certain degree of particularity, or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements as defined in the following claims.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions according to the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A system, comprising:
a processor; and
a memory configured to store an application, the application comprising processor-executable instructions that when executed by the processor, cause operations to be performed, the operations comprising:
receiving, from a first computing device over a network, a planning document of a construction project;
extracting, from the planning document, an item to be used in the construction project;
receiving, from a second computing device over the network, item demand data associated the item, the item demand data used in determining a demand for the item;
receiving, from a third computing device over the network, a user input associated with the item, the user input used in determining the demand for the item;
based on the item demand data and the user input, generating a forecast of item demand for the item; and
based on the forecast, transmitting, over the network, a notice to a supply chain system to acquire the item.

2. The system of claim 1, wherein the memory stores further process-executable instructions for:
prior to receiving the user input, generating a graphical user interface (GUI) configured to receive the user input; and
transmitting the graphical user interface to the third computing device, wherein the user input is received via the GUI.

3. The system of claim 2, wherein the memory stores further process-executable instructions for:
prior to generating the GUI, analyzing the item demand data; and
based on a determination that information associated with the item demand data is missing, generating the GUI configured to receive the user input, wherein the user input provides the information.

4. The system of claim 1, wherein the second computing devices comprises one of a vendor computing device or a contractor computing device.

5. The system of claim 1, wherein the second computing devices comprises one of a project team computing device or a designer computing device.

6. The system of claim 1, wherein the third computing device comprises a managing computing device.

7. The system of claim 1, wherein:
the supply chain system comprises a vendor; and
transmitting, over the network, the notice to the supply chain system to acquire the item comprises transmitting, over the network, the notice to the vendor to acquire the item.

8. The system of claim 1, wherein:
the supply chain system comprises a warehouse; and
transmitting, over the network, the notice to the supply chain system to acquire the item comprises transmitting, over the network, the notice to the warehouse to acquire the item.

9. The system of claim 1, wherein the planning document comprises a blueprint of the construction project.

10. A method, comprising:
receiving a blueprint of a construction project;
extracting, from the blueprint, an item to be used in the construction project;
receiving item demand data associated the item, the item demand data used in determining a demand for the item;
analyzing the item demand data to determine whether information associated with the item is missing;
based on a determination that information associated with the item is missing, transmitting a graphical user interface (GUI) to a computing device, the GUI configured to receive user inputs;
receiving, via the GUI, a user input associated with the item, the user input providing the missing information;
based on the item demand data and the user input, generating a forecast of item demand for the item; and
based on the forecast, transmitting a notice to a supply chain system to acquire the item.

11. The method of claim 10, wherein the blueprint is received as a computer-aided design blueprint.

12. The method of claim 10, wherein:
the supply chain system comprises a vendor; and
transmitting the notice to the supply chain system to acquire the item comprises transmitting the notice to the vendor to acquire the item.

13. The method of claim 10, wherein:
the supply chain system comprises a warehouse; and
transmitting the notice to the supply chain system to acquire the item comprises transmitting the notice to the warehouse to acquire the item.

14. The method of claim 10, wherein:
the GUI is a first GUI;
the user input is a first user input; and
the method further comprises:
prior to generating the forecast of item demand the item, determining information associated with the item demand data requires approval or confirmation; and
transmitting a second GUI a computing device, the second GUI configured to receive user inputs; and
receiving a second user input providing the approval.

15. The method of claim 10, wherein:
the GUI is a first GUI;
the user input is a first user input; and
the method further comprises:
prior to generating the forecast of item demand the item, determining an issue associated with the item demand data;
transmitting a second GUI a computing device, the second GUI configured to receive user inputs; and
receiving a second user input remedying the issue.

16. The method of claim 10, further comprising prior to generating the forecast of item demand the item, determining whether all of the item demand data and user inputs have been received.

17. A computer-readable medium having processor-executable instructions stored thereon, the processor-executable instructions, when executed by one or more processors, cause operations to be performed, the operations comprising:
receiving one or more planning documents of a construction project;
extracting, from the one or more planning documents, an item to be used in the construction project;
receiving item demand data associated the item, the item demand data used in determining a demand for the item;
analyzing the item demand data to determine whether information associated with the item is missing;
based on a determination that information associated with the item is missing, transmitting a graphical user interface (GUI) to a computing device, the GUI configured to receive user inputs;
receiving a user input associated with the item, the user input providing the missing information;
based on the item demand data and the user input, generating a forecast of item demand the item; and
based on the forecast, transmitting the forecast of item demand to a computing device, the computing device configured to execute a software application that is configured to transmit a notice to a supply chain system to acquire the item.

18. The computer-readable medium of claim 17, wherein:
the supply chain system comprises a vendor; and
transmitting the notice to the supply chain system to acquire the item comprises transmitting the notice to the vendor to acquire the item.

19. The computer-readable medium of claim 17, wherein:
the GUI is a first GUI;
the user input is a first user input; and
the processor-executable instructions cause further operations of:
prior to generating a forecast of item demand the item, determining information associated with the item demand data requires approval or confirmation; and
transmitting a second GUI a computing device, the second GUI configured to receive user inputs; and
receiving a second user input providing the approval.

20. The computer-readable medium of claim 17, wherein:
the GUI is a first GUI;
the user input is a first user input; and
the processor-executable instructions cause further operations of:
prior to generating a forecast of item demand the item, determining an issue associated with the item demand data exists;
transmitting a second GUI a computing device, the second GUI configured to receive user inputs; and
receiving a second user input remedying the issue.
